(19) United States
(12) Patent Application Publication
(10) Pub. No.: US 2007/0241064 A1
(43) Pub. Date: Oct. 18, 2007

(54) Method Of Compacting A Slurry By Pressure Filtration

(76) Inventor: Sanjay Bellara, Seascale (GB)

Correspondence Address: MOORE & VAN ALLEN PLLC, P.O. BOX 13706, Research Triangle Park, NC, 27709, US

(21) Appl. No.: 10/592,021

(22) PCT Filed: Mar. 10, 2005
(86) PCT No.: PCT/GB05/00934

§ 371 Date: Jun. 14, 2007

(30) Foreign Application Priority Data
Mar. 10, 2004 (GB) 0405323.7

(51) Int. Cl. B01D 37/00; C02F 1/00

(52) U.S. Cl. 210/770; 588/261

(57) ABSTRACT

The invention provides a method for the reduction of the volume of solid liquid dispersion or suspension, the method comprising the steps of: (a) providing a receptacle comprising at least one permeate a or semi-permeable membrane; (b) introducing the solid/liquid dispersion or suspension into the receptacle; and (c) applying a mechanical force so as to substantially expel the liquid and compact the solid residue; characterised in that the application of the mechanical force comprises the application of pressure to the solid/liquid dispersion or suspension by means of at least one solid mechanical member, the magnitude of the pressure being increased during the process. The receptacle generally comprises a barrel (1), the permeable or semi-permeable membrane is most preferably a filter (2), and the mechanical force is typically applied by means of a source of an inflatable air bag (4) or a hydraulic ram. The compaction of the solid residue from the waste material may additionally comprise compression of the receptacle. In all embodiments of the invention, the residue obtained is suitable for storage or disposal by any appropriate means. The solid/liquid dispersion or suspension preferably comprises an aqueous slurry of waste material, most preferably an Intermediate Liquid Waste slurry generated in the nuclear industry.

### FIELD OF THE INVENTION

The present invention relates to the disposal of waste and provides a novel method for the collection and dewatering and/or filtration of waste materials. The method is especially concerned with the safe disposal of waste sludge, and finds particular application in the disposal of waste materials which occur in the nuclear industry.

### BACKGROUND OF THE INVENTION

The identification of safe and environmentally acceptable disposal methods for waste materials generated in the nuclear industry is a constant source of challenge to workers in that industry. The enduring nature of radioactive contamination necessitates an ongoing search for new and innovative methods of treatment which facilitate the safe long term storage of these materials.

Many existing methods of disposal require the solidification of the waste materials by means of suitable encapsulants, and this has, in fact, proved to be an especially favoured method for the disposal of waste materials in the nuclear industry, since it provides a suitable means for the conversion of highly toxic materials into a stable and safe form, which allows for their long term storage and/or ultimate disposal.

In the nuclear industry wet, often fairly dilute, sludges have been generated for many years. They arise either from current operations, or from the desire to empty old storage vessels such as ponds and silos, and the procedure for disposal involves the preparation of the wastes for encapsulation for long term storage. These operations, particularly in the case of old ponds and silos, often require long settled sludges to be refluidised, transported significant distances to treatment plants, and packaged in a form suitable for long term storage. However, the final volume occupied by such wastes is greatly reduced, along with the costs associated with long term storage in a repository, if the water content of the sludges is reduced. Hence simple, robust methods for reducing the water content of these waste materials are highly desirable. Typically, fluid wastes of this type in the nuclear industry, for which dewatering and compaction are desirable, are stored directly in engineered drums. In most cases, radioactivity and long term storage requirements necessitate that the waste should eventually be grouted and overpacked with a cementitious material. Dewatering of such wastes is traditionally carried out in the nuclear and other industries by means of techniques such as sandbed filtration and cross-flow ultra-filtration, the products of such processes subsequently being encapsulated in cement, as described, for example, in Chapter 9 of “The Nuclear Fuel Cycle”, P D Wilson, Ed., Oxford Press, 1996. Unfortunately, however, these methods are unable to provide residual waste materials having a sufficiently low water content for ultimate disposal, or to produce sludges which are non-flowing. Thus, the present invention seeks to provide a more effective procedure for dewatering and/or filtration of liquid wastes, such that the water content is reduced to a significantly lower level than is possible by employing the methods of the prior art.

A particular form of waste which commonly occurs in the nuclear industry is a liquid-based slurry, containing significant amounts of solid material, an example being so-called Intermediate Liquid Waste. Consequently, the present invention seeks to provide a means by which a waste material of this type may be quickly and efficiently reduced in volume, the liquid removed to as great an extent as possible, and the residual solid significantly compacted, in order to provide a residue which has the potential for subsequent disposal and/or storage by means of encapsulation or a related technique. Alternatively, if the dewatered solid is not suitable for encapsulation, the method of the invention does at least provide the waste material in a more suitable form for long term storage than is the case with the original suspension or dispersion.

### STATEMENTS OF INVENTION

Thus, according to a first aspect of the present invention there is provided a method for the reduction of the volume of solid/liquid dispersion or suspension, said method comprising the steps of:
(a) providing a receptacle comprising at least one permeable or semi-permeable membrane;
(b) introducing said solid/liquid dispersion or suspension into said receptacle; and
(c) applying a mechanical force so as to substantially expel said liquid and compact the solid residue;
   characterised in that the application of said mechanical force comprises the application of pressure to said solid/liquid dispersion or suspension by means of at least one solid mechanical member, the magnitude of said pressure being increased during the process.

Preferably said solid/liquid dispersion or suspension comprises a slurry, most commonly an aqueous slurry, of a solid material. The invention is particularly applicable in cases where said solid/liquid dispersion comprises a waste material, most particularly a waste material generated in the nuclear industry.

Said receptacle generally comprises a cylindrical container, preferably a container such as a barrel, and said at least one permeable or semi-permeable membrane is most preferably a suitable filter device, typically a woven metal mesh material, which is integrated into the surface of the receptacle. Most conveniently, said at least one permeable or semi-permeable membrane is comprised in the base of said receptacle, thereby allowing for the introduction of the solid/liquid dispersion or suspension into the top of the receptacle, whereupon the liquid may partially permeate through the membrane, whilst the solid material is retained within the receptacle. Optionally, further permeable or semi-permeable membranes may be comprised in the top and/or sides of the receptacle.

The substantial expulsion of the liquid from the receptacle, and the subsequent compaction of the solid residue, relies on the application of a mechanical force by means of at least one solid member. Said mechanical force provides an increase in the pressure applied to the solid/liquid dispersion or suspension, such that the liquid comprised therein is forced, to the greatest extent possible, to pass through the at least one permeable or semi-permeable membrane; subsequently, compaction of the solid takes place.

According to a second aspect of the present invention, there is provided a method for the reduction of the volume of solid/liquid dispersion or suspension, said method comprising the steps of:
(a) reducing the volume of said solid/liquid dispersion or suspension according to the method of the first aspect of the invention; and
(b) compacting the receptacle by the application of a further mechanical force.

Preferably, said further mechanical force comprises very high pressure, which is preferably applied by the direct mechanical action of at least one solid mechanical member, for example, a rigid member such as a hammer, piston or hydraulic ram.

### DESCRIPTION OF THE INVENTION

The pressure applied to the solid/liquid dispersion or suspension is increased by the action of at least one solid mechanical member on the said dispersion or suspension. Most conveniently, said at least one mechanical member may comprise at least one inflatable member, placed within the receptacle and adapted to act on the dispersion or suspension when inflated in order to physically force the liquid through the at least one permeable or semi-permeable membrane. Subsequently, following expulsion of the liquid, the at least one inflatable member may be further inflated in order to act upon the residual solid and physically compact said solid. Preferably said at least one inflatable member may comprise at least one air bag, which may be inflated by the ingress of a supply of gas, preferably compressed air, provided from a suitable external supply. Optionally, said at least one inflatable member may additionally comprise at least one rigid member, to more effectively expel liquid from the residual solid and thereafter compact the residual solid. Said at least one rigid member may, for example, comprise at least one base plate, preferably comprised of metal.

In operation, all sections of the receptacle would be closed other than the at least one permeable or semi-permeable membrane and a means of ingress. Said at least one inflatable member would be attached to the means of ingress, and the supply of, typically, compressed air would be introduced, via said means of ingress, into said at least one inflatable member to inflate said at least one member and cause it/them to act on the dispersion or suspension.

Alternatively, the mechanical means for the application of pressure to the solid/liquid dispersion or suspension may consist only of at least one rigid member, such as a piston or ram, which acts directly on the receptacle containing the solid/liquid dispersion or suspension. Preferably, said rigid member is comprised of metal.

In any event, the pressure applied to the solid/liquid dispersion or suspension is gradually increased, such that the liquid comprised therein is forced, to the greatest extent possible, to pass through the at least one permeable or semi-permeable membrane and, subsequently, compaction of the solid takes place. The pressure applied is typically in the region of 5-200 bar, more preferably from 10-50 bar, but may be increased to any appropriate level, where necessary. Thus, for example, it would generally be the case that an initial pressure in the region of 5-20 bar would be applied, and this would be increased, over the duration of the process to a level of 100-200 bar, although higher pressures, for example, of up to 300 bar may sometimes be required to achieve maximum compaction. The application of the compression force in such a controlled manner assists in the achievement of an efficient filtration process, and avoids the possibility of filter blinding or cake blinding, wherein either the at least one membrane, or the solids residue itself, forms an impermeable structure, such that filtration and removal of liquor is unable to continue. Optionally, the applied pressure may be maintained at a low level until filtration is complete, and only thereafter significantly increased in order to achieve compaction of the solid residue.

In one preferred embodiment of the invention, further permeable or semi-permeable membranes may additionally be comprised inside said receptacle in order to provide extra filtration capacity. In said embodiment, means are provided for the removal of liquor which has been filtered through said further permeable or semi-permeable membranes. Preferably, in said preferred embodiment, said further permeable or semi-permeable membranes are provided by means of a plate filter, said plate filter comprising an internal cavity and surfaces comprising permeable or semi-permeable membranes. Preferably said plate filter comprises a disc comprised of metal and having an internal cavity, wherein the top and bottom of the disc are permeable and comprise metal filter media. Preferred means for the removal of liquor which has been filtered by said plate filter typically comprise hoses, preferably reinforced metal hoses, which are attached to said plate filter such that the expressed liquor may be directed away from said internal cavity.

In a further embodiment of the invention, it is envisaged that when the direct means for the application of pressure to the solid/liquid dispersion or suspension consists only of a rigid member, such as a piston or ram, which acts directly on the receptacle containing the solid/liquid dispersion or suspension, said rigid member may include holes or grooves adapted to further facilitate the egress of liquor from the system.

Optionally, following compaction of the solid residue, the receptacle containing the solid compacted material may be further compacted prior to encapsulation, or containment within a waste repository, according to which is most appropriate in the individual circumstances. Thus, following the introduction of the solid/liquid dispersion or suspension into the receptacle, and the compaction of the solid residue, a further direct mechanical force is applied to the receptacle so as to compress the receptacle and further compress the solid residue. The further direct mechanical force may be applied by any convenient means capable of effectively crushing and compacting the receptacle—typically, for example, by the action of a hydraulic ram—and is most conveniently applied to the top of the receptacle. Following the compacting procedure, the residual compacted solid, together with the remnants of the crushed receptacle, may be sent for storage or disposal by means of encapsulation, or containment within a waste repository, as appropriate.

The pressure applied to achieve compaction of the receptacle may be up to any level required in order to achieve the required objective. Generally, very high compacting forces of several hundreds of tonnes, typically from 200-2000 tonnes, preferably 1000-2000 tonnes, are applied to ensure maximum compaction.

The method of the present invention is especially suitable for the processing of waste slurries and finds particular application in the treatment of waste slurries produced in the nuclear industry, notably in the treatment of Intermediate Liquid Waste in preparation for its ultimate storage and/or disposal by encapsulation, containment or other suitable means.

### DETAILED DESCRIPTION OF THE DRAWINGS

The method of the invention will now be illustrated, though without limitation, by reference to the accompanying diagrams, in which:

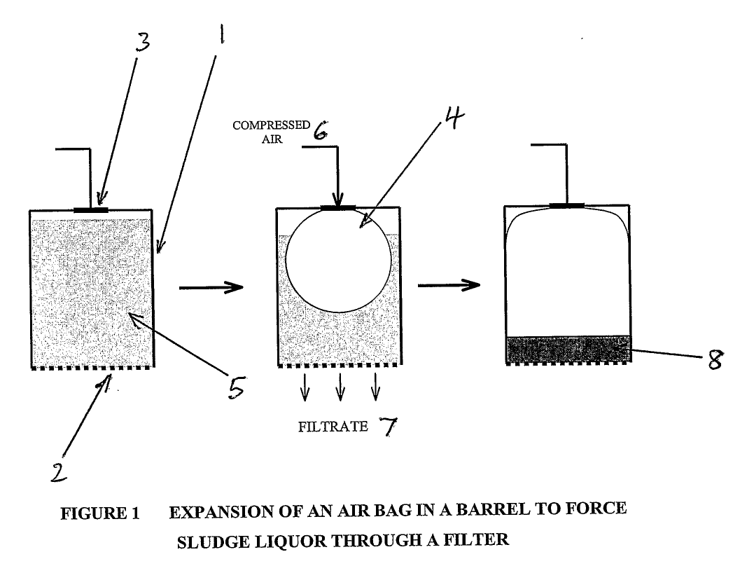

FIG. 1 illustrates a first embodiment of the method of the invention, wherein the pressure applied to the solid/liquid dispersion or suspension is increased by means of an inflatable air bag placed within the receptacle but the receptacle is not compacted;

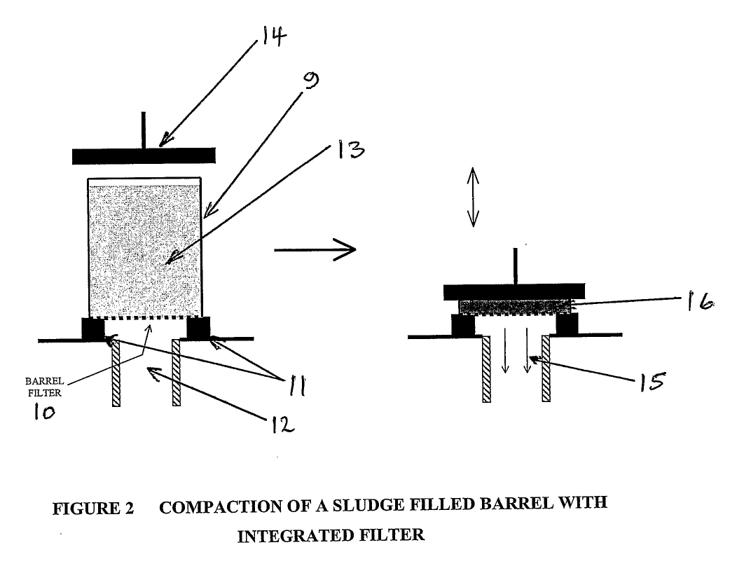

FIG. 2 illustrates a second embodiment of the method of the invention, wherein the pressure applied to the solid/liquid dispersion or suspension is increased by means of a hydraulic ram, which compacts both the solid residue and the receptacle;

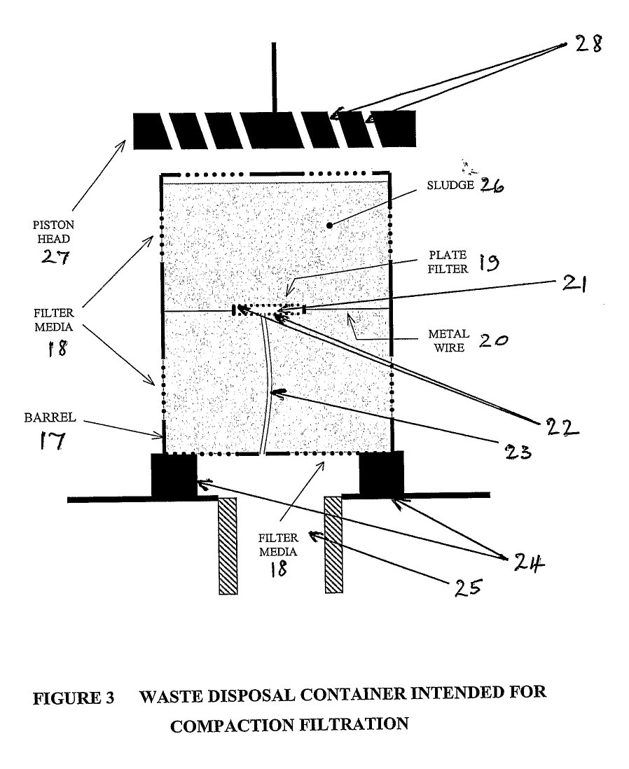

FIG. 3 illustrates an embodiment of the method of the invention, wherein the pressure applied to the solid/liquid dispersion or suspension is increased by means of a hydraulic ram, which compacts both the solid residue and the receptacle, and wherein the receptacle contains multiple permeable or semi-permeable membranes and the hydraulic ram contains holes or grooves; and

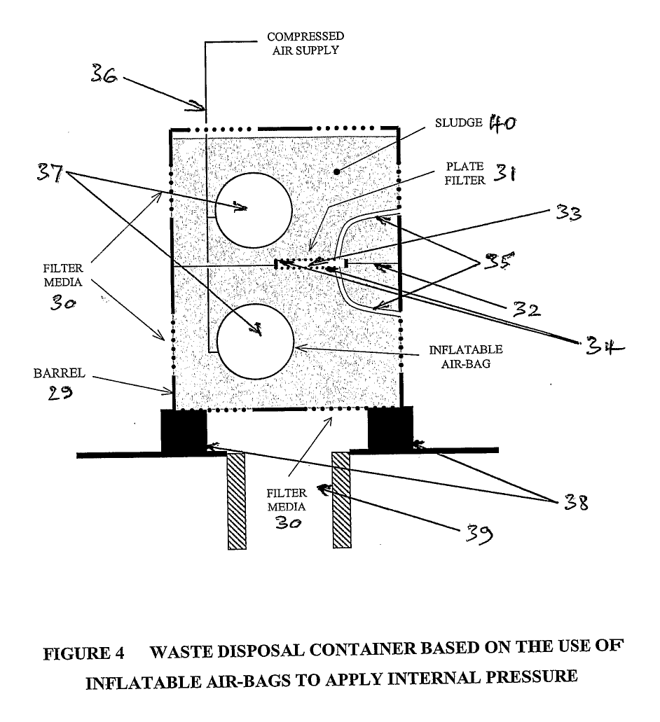

FIG. 4 illustrates an embodiment of the method of the invention, wherein the pressure applied to the solid/liquid dispersion or suspension is increased by means of an inflatable air bag placed within the receptacle but the receptacle is not compacted, and the receptacle contains multiple permeable or semi-permeable membranes.

Referring firstly to FIG. 1, there is shown a receptacle in the form of a barrel 1 comprising a semi-permeable membrane comprising a filter 2 and a lid 3 incorporating an orifice (not shown) to which is attached an inflatable air bag 4. A solid/liquid suspension 5 is introduced into the barrel 1 and supply of compressed air 6 is introduced into the air-bag 4 via the orifice, so as to gradually inflate the air bag 4, thereby initially forcing the liquid filtrate 7 to exit through the filter 2, whilst the solid is retained on the filter 2. Subsequently, the air bag 4 is fully inflated, in order that the residue 8 becomes compacted on the filter 2.

Turning now to FIG. 2, there is shown a receptacle in the form of a barrel 9 comprising a semi-permeable membrane comprising a filter 10. The barrel 9 is placed on supporting members comprising blocks 11 above a drainage duct 12. A solid/liquid suspension 13 is introduced into the barrel 9 and said barrel is then sealed. A hydraulic ram 14 located above the barrel 9 is then caused to act on said barrel in a downward motion with steadily increasing pressure, thereby forcing the liquid filtrate 15 to exit through the filter 10, whilst at the same time compacting the solid. The pressure applied by the ram 14 is then further increased so as to crush the barrel 9 to leave a compacted mass 16 on the blocks 11.

In FIG. 3, there is shown a receptacle in the form of a barrel 17 comprising a plurality of semi-permeable membranes comprising filter media 18 and a plate filter 19 supported by a metal wire 20, said plate filter comprising an internal cavity 21 and surfaces comprising filter media 22, and being connected to a reinforced metal hose 23. The barrel 17 is placed on supporting members comprising blocks 24 above a drainage duct 25. A solid/liquid suspension comprising sludge 26 is introduced into the barrel 17 and said barrel is then sealed. A hydraulic ram 27 comprising filtration ducts 28 located above the barrel 17 is then caused to act on said barrel in a downward motion with steadily increasing pressure, thereby forcing liquid filtrate to exit through the filter media 18 and 22 and the filtration ducts 28, whilst at the same time compacting the solid. The pressure applied by the ram 27 is then further increased so as to crush the barrel 17 to leave a compacted mass on the blocks 24.

Referring finally to FIG. 4, there is shown a receptacle in the form of a barrel 29 comprising a plurality of semi-permeable membranes comprising filter media 30 and a plate filter 31 supported by a metal wire 32, said filter media comprising an internal cavity 33 and surfaces comprising filter media 34, and being connected to reinforced metal hoses 35. A pipe 36 is provided in the top of said barrel, said pipe passing via an orifice (not shown) in said filter media 30 and being connected to inflatable air bags 37. The barrel 29 is placed on supporting members comprising blocks 38 above a drainage duct 39. A solid/liquid suspension comprising sludge 40 is introduced into the barrel 29 and said barrel is then sealed and a supply of compressed air is introduced into the air-bag 37 via the pipe 36, so as to gradually inflate the air bags 37, thereby initially forcing liquid filtrate to exit through the filter media 30 and 34, whilst the solid is retained on the said filter media. Subsequently, the air bags 37 are fully inflated, in order that the solid residue becomes compacted on the filter media 30 and 34.

1. A method for the reduction of the volume of solid/liquid dispersion or suspension, said method comprising the steps of:
(a) providing a receptacle comprising at least one permeable or semi-permeable membrane;
(b) introducing said solid/liquid dispersion or suspension into said receptacle; and
(c) applying a mechanical force so as to substantially expel said liquid and compact the solid residue;
wherein said mechanical force comprises the application of pressure to said solid/liquid dispersion or suspension by means of at least one solid mechanical member, and wherein the magnitude of said pressure being increased during the process.

2. The method as claimed in claim 1 wherein said solid/liquid dispersion or suspension comprises a slurry of a solid material.

3. The method as claimed in claim 2 wherein said slurry comprises an aqueous slurry.

4. The method as claimed in claim 1 wherein said solid/liquid dispersion comprises a waste material.

5. The method as claimed in claim 4 wherein said waste material comprises a waste material generated in the nuclear industry.

6. The method as claimed in claim 1 wherein said receptacle comprises a cylindrical container.

7. The method as claimed in claim 6 wherein said cylindrical container comprises a barrel.

8. The method as claimed in claim 1 wherein said permeable or semi-permeable membrane comprises a filter.

9. The method as claimed in claim 8 wherein said filter comprises a woven metal mesh material.

10. The method as claimed in claim 8 wherein said permeable or semi-permeable membrane is integrated into the surface of the receptacle.

11. The method as claimed in claim 8 wherein said permeable or semi-permeable membrane is comprised in the base of said receptacle.

12. The method as claimed in claim 11 wherein said permeable or semi-permeable membrane is additionally comprised in the top and/or sides of said receptacle.

13. The method as claimed in claim 1 wherein said application of a mechanical force to substantially expel said liquid from said receptacle and compact said solid residue provides an increase in the pressure applied to said solid/liquid dispersion or suspension.

14. The method as claimed in claim 13 wherein said increase in the pressure applied to said solid/liquid dispersion or suspension is achieved gradually by the action of at least one solid mechanical member on said dispersion or suspension.

15. The method as claimed in claim 14 wherein said at least one mechanical member comprises at least one inflatable member located within said receptacle.

16. The method as claimed in claim 15 wherein said at least one inflatable member comprises at least one air bag.

17. The method as claimed in claim 16 wherein said at least one inflatable member is inflated by the ingress of compressed air.

18. The method as claimed in claim 15, wherein said at least one inflatable member additionally comprises at least one rigid member.

19. The method as claimed in claim 18 wherein said at least one rigid member comprises at least one base plate.

20. The method as claimed in claim 19 wherein said at least one base plate is comprised of metal.

21. The method as claimed in claim 1 wherein said mechanical force is applied to the top of the receptacle.

22. The method as claimed in claim 21 wherein said mechanical force is applied by the action of a rigid member.

23. The method as claimed in claim 23 wherein said rigid member comprises a piston or hydraulic ram.

24. The method as claimed in claim 23 wherein said rigid member is comprised of metal.

25. The method as claimed in claim 24 wherein said rigid member includes holes or grooves adapted to further facilitate the egress of liquor from the system.

26. The method as claimed in claim 1 wherein the pressure applied to the solid/liquid dispersion or suspension is in the region of 5-200 bar.

27. The method as claimed in claim 26 wherein said pressure is in the region of 10-50 bar.

28. The method as claimed in claim 26 wherein an initial pressure in the region of 5-20 bar is applied to said solid/liquid dispersion, and said pressure is increased to a level of 100-200 bar.

29. The method as claimed in claim 1 wherein a pressure of 300 bar is applied to achieve maximum compaction.

30. The method as claimed in claim 1 wherein further permeable or semi-permeable membranes are comprised inside said receptacle.

31. The method as claimed in claim 30 wherein said further permeable or semi-permeable membranes are provided by means of a plate filter.

32. The method as claimed in claim 31 wherein said plate filter comprises an internal cavity and surfaces comprising permeable or semi-permeable membranes.

33. The method as claimed in claim 31 wherein said plate filter comprises a disc comprised of metal and having an internal cavity, wherein the top and bottom of said disc are permeable and comprise metal filter media.

34. The method as claimed in claim 30 wherein means are provided for the removal of liquor which has been filtered through said further permeable or semi-permeable membranes.

35. The method as claimed in claim 34 wherein said means for the removal of said liquor comprise hoses which are attached to said plate filter such that the expressed liquor may be directed away from said internal cavity.

36. The method as claimed in claim 35 wherein said hoses comprise reinforced metal hoses.

37. A method for the reduction of the volume of solid/liquid dispersion or suspension, said method comprising the steps of:
(a) reducing the volume of said solid/liquid dispersion or suspension according to the method as claimed in any preceding claim; and
(b) compacting the receptacle by the application of a further mechanical force.

38. The method as claimed in claim 37 wherein said further mechanical force comprises very high pressure.

39. The method as claimed in claim 38 wherein said further mechanical force is applied by the direct mechanical action of at least one solid mechanical member.

40. The method as claimed in claim 39 wherein said at least one solid mechanical member comprises a hammer, piston or hydraulic ram.

41. The method as claimed in claim 37 wherein a compaction force of several hundreds of tonnes is applied to achieve maximum compaction of the receptacle.

42. The method as claimed in claim 41 wherein said compaction force is 200-2000 tonnes.

43. The method as claimed in claim 42 wherein said compaction force is 1000-2000 tonnes.

44. The method as claimed in claim 37 wherein the residue is subsequently despatched for storage or disposal.

45. The method as claimed in claim 37 whenever applied to the treatment of Intermediate Liquid Waste in the nuclear industry.
